(19) United States
(12) Patent Application Publication
(10) Pub. No.: US 2018/0312020 A1
(43) Pub. Date: Nov. 1, 2018

(54) MONITORING DEVICE AND TIRE PRESSURE MONITORING SYSTEM

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Makoto SABURI, Yokkaichi-shi (JP); Yoshihiro HAMADA, Osaka-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 15/769,628

(22) PCT Filed: Oct. 18, 2016
(86) PCT No.: PCT/JP2016/080779

§ 371 Date: Apr. 19, 2018

(30) Foreign Application Priority Data
Oct. 20, 2015 (JP) 2015-206644

(51) Int. Cl. B60C 23/04

(52) U.S. Cl. CPC B60C 23/0438

(57) ABSTRACT

A tire pressure monitoring system includes a plurality of detection devices that are provided a plurality of tires of a vehicle and each wirelessly transmit an air pressure signal including air pressure information in response to a request signal and a monitoring device that transmits the request signal to each of the detection devices and receives the air pressure signal transmitted from each of the detection devices in response to the request signal, to monitor air pressure of each of the tires. The monitoring device includes a request signal transmitting unit that transmits the request signal to a region including one tire position and an air pressure signal receiving unit that receives an air pressure signal. The monitoring device determines whether or not the air pressure signals transmitted from the plurality of detection devices are received and changes the transmission strength of the request signal depending on the determination result.

### TECHNICAL FIELD

The present invention relates to a monitoring device and a tire pressure monitoring system.

The present application claims the benefit of Japanese Patent Application No. 2015-206644 filed on Oct. 20, 2015, the entire contents of which are herein incorporated by reference.

### BACKGROUND ART

A tire pressure monitoring system (TPMS) has been known that detects the air pressure of a tire mounted on a vehicle, and issues an alarm or the like to the user if the detected air pressure is abnormal. The tire pressure monitoring system includes a detection device that detects air pressure of each tire and wirelessly transmits an air pressure signal concerning the detected air pressure by a radio wave in the UHF band and a monitoring device that receives the air pressure signal wirelessly transmitted from the detection device and monitors the air pressure of each tire based on the air pressure signal received. The detection device is provided in each of the multiple tires while the monitoring device is provided in the body of the vehicle. The monitoring device is connected to multiple low frequency (LF) transmitting antennas that are disposed near the respective tires and individually transmit by a radio wave in the LF band a request signal for requesting air pressure of each tire to respective detection devices. When receiving a request signal transmitted from the monitoring device, each detection device detects air pressure of each tire and wirelessly transmits an air pressure signal including the detected air pressure information to the monitoring device. The monitoring device receives the air pressure signal transmitted from each of the detection devices and monitors air pressure of each tire.

However, a request signal transmitted to the detection device of one tire may be received by this detection device as well as by a detection device of another tire, which may cause the multiple detection devices to transmit air pressure signals. Furthermore, detection devices provided in the tires of an adjacent vehicle may transmit air pressure signals to the monitoring device in response to the request signal. When thus receiving the air pressure signal from a detection device other than the intended detection device, the monitoring device may monitor the air pressure by using erroneous air pressure information.

In addition, when air pressure signals are simultaneously transmitted from multiple detection devices to the monitoring device, interference may occur between the air pressure signals, which may prevent the monitoring device from receiving the air pressure signals.

Patent Document 1 discloses a tire pressure monitoring system in which a monitoring device transmits a request signal including tire identification information and vehicle identification information to a detection device. The detection device determines whether or not the tire identification information and the vehicle identification information that are included in the received request signal match with tire identification information and vehicle identification information that are previously registered, and transmits an air pressure signal to the monitoring device if it is determined that they match with each other. In the tire pressure monitoring system thus configured, no air pressure signal is transmitted from a detection device other than the intended detection device.

In order for four tires to evenly wear out, a tire rotation that interchanges the positions of the tires mounted on a vehicle has typically been performed. The tire pressure monitoring system according to Patent Document 1 makes antennas provided near the respective positions of the tires to transmit tire identification information of the four tires mounted on the vehicle and receives a response from each of the detection devices, thereby determines a positional relation between each tire position and the tire identifying information as well as updates and registers the tire identifying information.

### PRIOR ART DOCUMENT

### Patent Document

[Patent Document 1] Japanese Patent Application Laid-Open Publication No. 2005-193861

### SUMMARY OF INVENTION

A monitoring device according to one aspect of the present invention that receives an air pressure signal transmitted from each of a plurality of detection devices that are provided in respective ones of a plurality of tires of a vehicle in response to a request signal requesting air pressure of each of the tires, to monitor air pressure of each of the tires, comprises: a request signal transmitting unit that transmits the request signal to a region including at least one tire position where one of the tires is provided; an air pressure signal receiving unit that receives the air pressure signal transmitted from each of the detection devices in response to the request signal with respect to the region transmitted by the request signal transmitting unit; a determination unit that determines whether or not the air pressure signals transmitted from the plurality of detection devices are received by the air pressure signal receiving unit; and a transmission strength changing unit that increases or reduces a transmission strength of the request signal depending on a result determined by the determination unit.

A tire pressure monitoring system according to one aspect of the present invention comprises: a plurality of detection devices that are provided in respective ones of a plurality of tires of a vehicle and each wirelessly transmit an air pressure signal obtained by detecting air pressure of each of the tires in response to a request signal; and the monitoring device, and the monitoring device receives the air pressure signals transmitted from the plurality of detection devices, to monitor air pressure of the tires.

It is noted that the present application may be embodied as a monitoring device and a tire pressure monitoring system having such characteristic processing units, as well as being embodied as a tire pressure monitoring method including such characteristic processing steps, or embodied as a program that causes a computer to execute such steps. Furthermore, the present application may be embodied as a semiconductor integrated circuit for embodying a part or all of the tire pressure monitoring system, or the monitoring device, or embodied as another system including the tire pressure monitoring system or the monitoring device.

### BRIEF DESCRIPTION OF DRAWINGS

FIG. 1 is a schematic view illustrating an example of the configuration of a tire pressure monitoring system according to Embodiment 1 of the present invention.

FIG. 2 is a block diagram illustrating an example of the configuration of a monitoring device.

FIG. 3 is a conceptual diagram illustrating an example of a transmission strength table.

FIG. 4 is a block diagram illustrating an example of the configuration of a detection device.

FIG. 5 is a flowchart illustrating transmission strength adjustment processing procedure and tire pressure monitor processing according to Embodiment 1.

FIG. 6 is a flowchart illustrating the transmission strength adjustment processing procedure and tire pressure monitor processing according to Embodiment 1.

FIG. 7 is a flowchart illustrating transmission strength adjustment processing procedure and tire pressure monitor processing according to Embodiment 2.

### MODES FOR CARRYING OUT THE INVENTION

### Problems to be Solved by the Disclosure

In a tire pressure monitoring system according to Patent Document 1, when the correspondence between a tire position and tire identifying information is updated after a tire rotation is performed, in the case where a plurality of detection devices respond, the positional relation between each of the tire positions and tire identifying information may erroneously be recognized and stored. Furthermore, in the case where a spare tire provided with a detection device storing the tire identifying information and the vehicle identifying information is mounted on a vehicle, the tire identifying information of the spare tire and a specific tire position may erroneously be associated based on a response from the spare tire. In either case, it is impossible to normally monitor air pressures of tires.

In addition, the vehicle identifying information is required to be previously stored in the detection device provided in each tire, which has caused a problem in which if a tire that does not store the vehicle identifying information is mounted on a vehicle, the detection device does not work.

An object of the present invention is to provide a monitoring device and a tire pressure monitoring system that are capable of preventing occurrence of interference of air pressure signals transmitted from the detection devices provided in the tires at the respective tire positions.

### Effects of the Disclosure

According to the above description, it is possible to provide a monitoring device and a tire pressure monitoring system that are capable of preventing occurrence of interference of air pressure signals transmitted from the detection devices provided in the tires at the respective tire positions.

### DESCRIPTION OF EMBODIMENTS OF THE INVENTION

Embodiments of the present invention are first listed. It is noted that at least parts of the embodiments described below may arbitrarily be combined.

(1) A monitoring device according to one aspect of the present invention that receives an air pressure signal transmitted from each of a plurality of detection devices that are provided in respective ones of a plurality of tires of a vehicle in response to a request signal requesting air pressure of each of the tires, to monitor air pressure of each of the tires, comprises: a request signal transmitting unit that transmits the request signal to a region including at least one tire position where one of the tires is provided; an air pressure signal receiving unit that receives the air pressure signal transmitted from each of the detection devices in response to the request signal with respect to the region transmitted by the request signal transmitting unit; a determination unit that determines whether or not the air pressure signals transmitted from the plurality of detection devices are received by the air pressure signal receiving unit; and a transmission strength changing unit that increases or reduces a transmission strength of the request signal depending on a result determined by the determination unit.

According to this aspect, the request signal transmitting unit transmits a request signal to a region including at least one tire position. The detection device provided in the tire at the one tire position transmits an air pressure signal to the monitoring device in response to the request signal. However, a detection device at another tire position or a detection device of another vehicle may also receive the request signal. In this case, an air pressure signal is transmitted from a detection device of another tire that is provided or arranged at a position other than the one tire position to the monitoring device.

Hence, the monitoring device transmits a request signal at a predetermined timing and determines whether or not air pressure signals transmitted from the plurality of detection devices in response to the request signal are received. A predetermined timing is not limited to a particular timing, and examples include when an ignition switch is switched from an OFF state to an ON state, when an accessory power supply is switched from the OFF state to the ON state, when a battery power supply is switched from the OFF state to the ON state, and the like. The monitoring device then increases or reduces a transmission strength of the request signal depending on the determination result. That is, the monitoring device increases or reduces the transmission strength of a request signal such that a single detection device responds to the transmitted request signal. Typically, the detection device positioned closest to the transmission source of a request signal transmitted to a region including the one tire position is the detection device provided in the tire at the one tire position. By increasing or reducing the transmission strength of a request signal, only the detection device provided in the tire at the one tire position may be configured to receive a request signal and transmit an air pressure signal in response to the request signal. Accordingly, the monitoring device may prevent interference between air pressure signals of tires from occurring and receive an air pressure signal transmitted from the detection device at the one tire position. The transmission strength of a request signal to be transmitted to another tire position is also similarly adjusted.

Thus, according to this aspect, it is possible to prevent transmission of an air pressure signal from a detection device other than the detection device that is requested to transmit an air pressure signal, to prevent occurrence of interference between air pressure signals transmitted from the detection devices provided in the tires at the respective tire positions and to receive a required air pressure signal.

(2) It is preferable that the transmission strength changing unit increases a transmission strength of the request signal to be transmitted by the request signal transmitting unit in a case where the determination unit determines that the air pressure signal transmitted from one of the detection devices in response to the request signal transmitted at a predetermined timing is received.

According to this aspect, the monitoring device increases the transmission strength of the request signal in a case where an air pressure signal transmitted from a single detection device in response to the request signal transmitted at a predetermined timing is received. By increasing the transmission strength of a request signal, the detection device provided in the tire at the one tire position may be more likely to successfully receive a request signal.

(3) It is preferable that the request signal transmitting unit is configured to resend the request signal increased in transmission strength, and the transmission strength changing unit increases again a transmission strength of the request signal to be transmitted by the request signal transmitting unit in a case where the determination unit determines that the air pressure signal transmitted from one of the detection devices in response to the request signal that is resent is received.

According to this aspect, in a case that the monitoring device has increased the transmission strength of a request signal, it resends the request signal, and determines whether or not an air pressure signal transmitted from a single detection device in response to the request signal is received. If it is determined that the air pressure signal transmitted from a single detection device is received by the air pressure signal receiving unit, the transmission strength changing unit further increases the transmission strength of a request signal.

The detection device provided in the tire at the one tire position may be much more likely to successfully receive a request signal.

(4) It is preferable that processing is repeated for increasing a transmission strength of the request signal to be transmitted by the request signal transmitting unit and resending the request signal increased in transmission strength until the determination unit determines that the air pressure signals transmitted from the plurality of detection devices are received, and the transmission strength changing unit reduces a transmission strength of the request signal to be transmitted by the request signal transmitting unit in a case where the determination unit determines that the air pressure signals transmitted from the plurality of detection devices in response to the request signal that is resent are received.

According to this aspect, the monitoring device gradually increases the transmission strength of a request signal until it receives air pressure signals transmitted from a plurality of detection devices in response to the request signal. When receiving air pressure signals transmitted from the plurality of detection devices, the monitoring device reduces the transmission strength of a request signal by one level.

Thus, in this aspect, it is possible to prevent an air pressure signal from being transmitted from a detection device other than the detection device that is requested to transmit an air pressure signal and to also set the transmission strength of a request signal to be large.

(5) It is preferable that the transmission strength changing unit reduces a transmission strength of the request signal to be transmitted by the request signal transmitting unit in a case where the determination unit determines that the air pressure signals transmitted from the plurality of detection devices in response to the request signal transmitted at a predetermined timing are received.

According to this aspect, in a case of receiving the air pressure signals transmitted from the plurality of detection devices, the monitoring device reduces the transmission strength of a request signal. By reducing the transmission strength of a request signal, the detection device in the tire at a position other than the one tire position may be less likely to receive a request signal.

(6) It is preferable that the request signal transmitting unit is configured to resend the request signal reduced in transmission strength, and the transmission strength changing unit reduces again a transmission strength of the request signal to be transmitted by the request signal transmitting unit in a case where the determination unit determines that the air pressure signals transmitted from the plurality of detection devices in response to the request signal that is resent are received.

According to this aspect, in the case where the transmission strength of a request signal was reduced, the monitoring device resends a request signal and determines whether or not an air pressure signal transmitted from a single detection device in response to the request signal is received. The transmission strength changing unit further reduces the transmission strength of a request signal in the case where it is determined that the air pressure signal receiving unit receives the air pressure signals transmitted from the plurality of detection devices.

Thus, the detection device in the tire at a position other than the one tire position may be much less likely to receive a request signal.

(7) It is preferable that processing is repeated for reducing the transmission strength of the request signal to be transmitted by the request signal transmitting unit and resending the request signal reduced in transmission strength until the determination unit determines that the air pressure signal transmitted from one of the detection devices is received.

According to this aspect, the monitoring device gradually reduces the transmission strength of the request signal until it receives an air pressure signal transmitted from a single detection device.

Thus, in this aspect, it is possible to prevent an air pressure signal from being transmitted from a detection device other than the detection device that is requested to transmit an air pressure signal and to also set the transmission strength of a request signal to be large.

(8) It is preferable that a storage unit is further provided for storing a changed transmission strength in a case where the transmission strength changing unit completes the processing for increasing or decreasing a transmission strength of the request signal, and the request signal is transmitted at a transmission strength stored by the storage unit in a case where the storage unit stores a transmission strength, to monitor air pressure of each of the tires

According to this aspect, the storage unit stores the changed transmission strength of the request signal. In a case where the storage unit stores a transmission strength, the monitoring device transmits the request signal at the transmission strength stored in the storage unit, to monitor the air pressure of each tire.

(9) A tire pressure monitoring system according to one aspect of the present invention comprises a plurality of detection devices that are provided in respective ones of a plurality of tires of a vehicle and each wirelessly transmit an air pressure signal obtained by detecting air pressure of each of the plurality of tires in response to a request signal; and the monitoring device described in any one of the aspects (1) to (8), and the monitoring device receives the air pressure signals transmitted from the plurality of detection devices, to monitor air pressure of the respective tires.

According to this aspect, similar to the aspect (1), it is possible to prevent transmission of an air pressure signal from an external device other than the detection device from which an air pressure signal is requested, such as a detection device provided in another tire and a detection device provided in another vehicle, to prevent occurrence of interference between air pressure signals transmitted from the detection devices provided in the tires at the respective tire positions and to receive a desired air pressure signal.

### DETAILED DESCRIPTION OF THE INVENTION

Examples of a tire pressure monitoring system according to the embodiments of the present invention will be described below in detail with reference to the drawings. It is to be understood that the embodiments disclosed herein are illustrative in all respects and not restrictive, and all changes that fall within the meanings and the bounds of the claims, or equivalence of such meanings and bounds are intended to be embraced by the claims.

### Embodiment 1

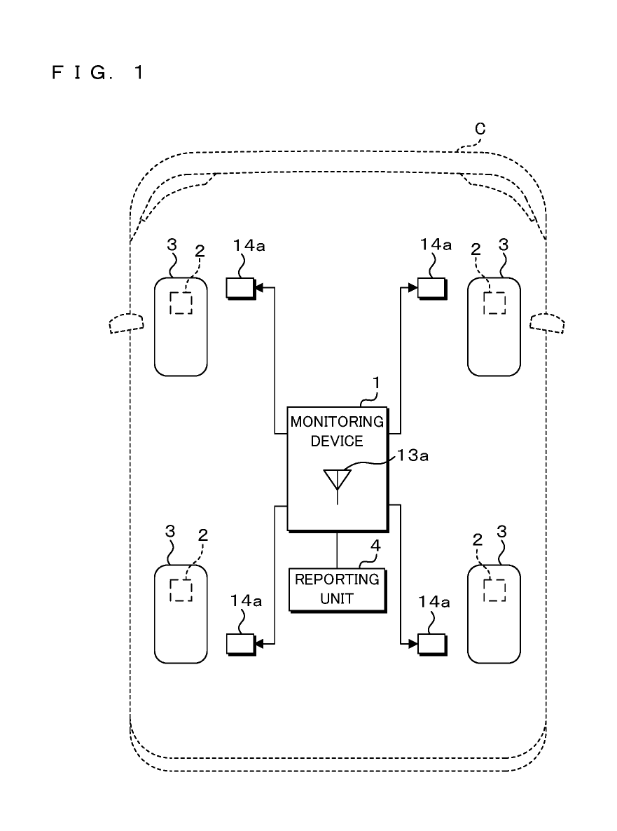

FIG. 1 is a schematic view illustrating an example of the configuration of a tire pressure monitoring system according to Embodiment 1 of the present invention. The tire pressure monitoring system according to Embodiment 1 includes a monitoring device 1 provided at an appropriate position of a vehicle body, detection devices 2 provided in the respective wheels of tires 3 mounted on a vehicle C and a reporting device 4. In the tire pressure monitoring system according to Embodiment 1, the monitoring device 1 performs wireless communication with each detection device 2 to obtain air pressure information of each tire 3 while the reporting device 4 makes a report in accordance with the obtained air pressure information. The monitoring device 1 is connected to LF transmitting antennas 14a corresponding to the respective tires 3. For example, the multiple LF transmitting antennas 14a are biased toward the right front, left front, right rear and left rear portions of the vehicle C. The LF transmitting antenna 14a positioned at the right front of the vehicle C may locally transmit signals by radio to a region including the tire position at the right front. The other LF transmitting antennas 14a may similarly transmit signals by radio to respective regions including the left front, right rear and left rear positions. The monitoring device 1 separately transmits by a radio wave in the LF band a request signal for requesting air pressure information to each of the detection devices 2 from each of the LF transmitting antennas 14a. The detection device 2 transmits by a radio wave in the ultra high frequency (UHF) band an air pressure signal including air pressure information obtained by detecting the air pressure of the tire 3 to the monitoring device 1 in response to the request signal transmitted from the monitoring device 1. The monitoring device 1 includes an RF receiving antenna 13a with which an air pressure signal transmitted from each of the detection devices 2 is received and obtains air pressure information of each tire 3 from the air pressure signal. Note that the LF band and the UHF band are mere examples of the radio wave band utilized when wireless communication is performed, and the radio wave band is not necessarily limited thereto. The monitoring device 1 is connected to the reporting device 4 via a communication line, and it transmits the obtained air pressure information to the reporting device 4. The reporting device 4 receives the air pressure information transmitted from the monitoring device 1 and reports the air pressure information of each of the tires 3. Furthermore, the reporting device 4 issues an alarm if the air pressure of the tire 3 is less than a predetermined threshold.

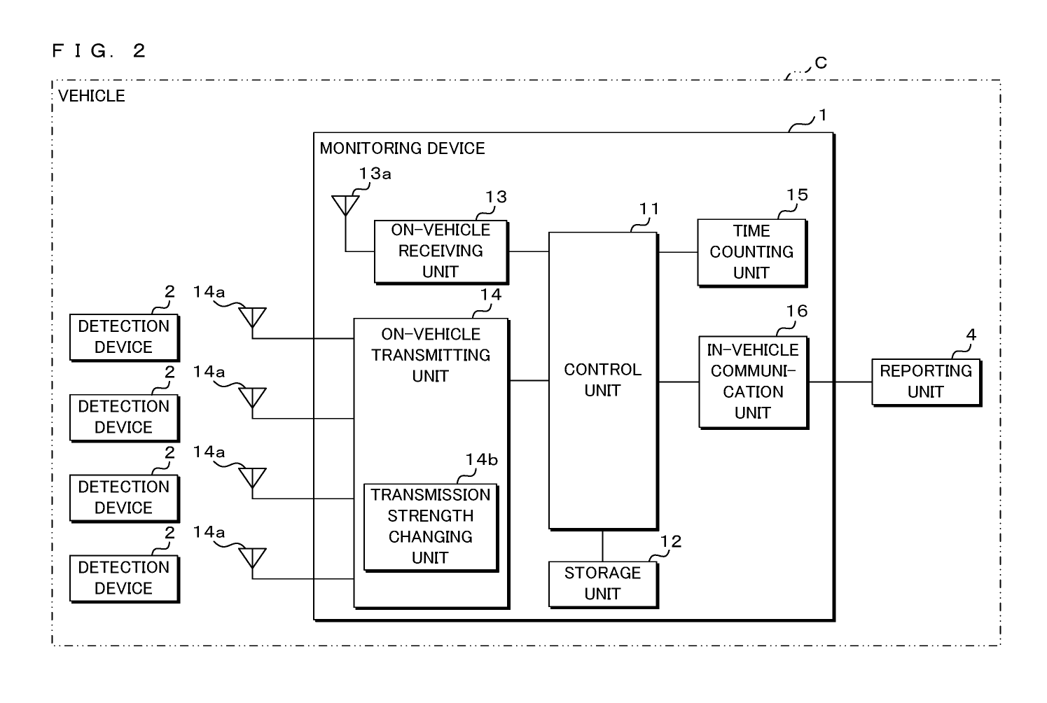

FIG. 2 is a block diagram illustrating an example of the configuration of the monitoring device 1. The monitoring device 1 includes a control unit 11 for controlling operation of respective components of the monitoring device 1. The control unit 11 is connected to a storage unit 12, an on-vehicle receiving unit 13, an on-vehicle transmitting unit 14, a time counting unit 15 and an in-vehicle communication unit 16.

The control unit 11 is a microcomputer including, for example, one or more central processing units (CPUs), a multi-core CPU, read-only memory (ROM), random access memory (RAM) and an input/output (I/O) interface, and soon. The CPU of the control unit 11 is connected to the storage unit 12, the on-vehicle receiving unit 13, the on-vehicle transmitting unit 14, the time counting unit 15 and the in-vehicle communication unit 16 via the I/O interface. The control unit 11 controls operation of the respective components by executing control programs stored in the storage unit 12, to thereby execute transmission strength adjustment processing and tire pressure monitoring processing according to the present embodiment.

The storage unit 12 is a nonvolatile memory such as an electrically erasable programmable ROM (EEPROM) and a flash memory. The storage unit 12 stores control programs for executing transmission strength adjustment processing and tire pressure monitor processing by the control unit 11 controlling the operation of the components of the monitoring device 1. The storage unit 12 further stores a transmission strength table indicating transmission strength at a time when a request signal is transmitted from each LF transmitting antenna 14a to the corresponding detection device 2.

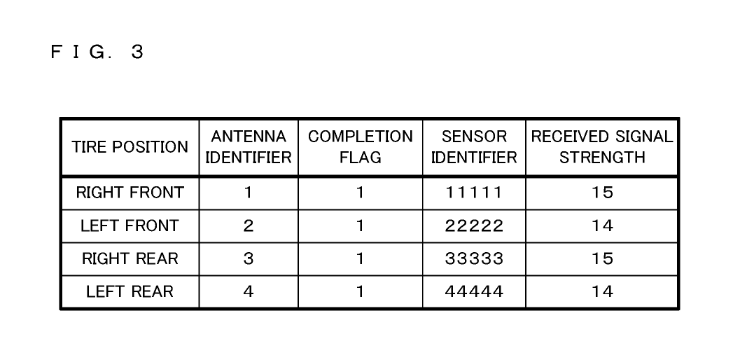

FIG. 3 is a conceptual diagram illustrating an example of the transmission strength table. In the transmission strength table, a tire position, an antenna identifier for identifying each of the LF transmitting antennas 14a, a completion flag for indicating whether or not adjustment of the transmission strength of a request signal is completed, a sensor identifier for identifying the detection device 2 corresponding to each of the LF transmitting antennas 14a and transmission strength of a request signal are registered in association with each other.

The completion flag value _1: means that adjustment of the transmission strength is completed while the completion flag value _0: means that adjustment of the transmission strength is not completed. The completion flag is reset to _0: when an ignition switch is switched from an OFF state to an ON state, for example. Note that the completion flag may be changed to _0: when an accessory power supply is switched from the OFF state to the ON state, or when a battery power supply is switched from the OFF state to the ON state.

The transmission strength of a request signal is represented by transmission electric power, while the transmission electric power is classified into multiple levels, and the multiple levels indicating the transmission strengths are registered as numerical values in the transmission strength table.

The on-vehicle receiving unit 13 is connected to the RF receiving antenna 13a. The on-vehicle receiving unit 13 receives by the RF receiving antenna 13a a signal transmitted by a radio wave in the RF band from the detection device 2. The on-vehicle receiving unit 13 is a circuit for demodulating the received signal and outputting the demodulated signal to the control unit 11. A radio wave of the UHF band in the range of 300 MHz to 3 GHz is employed as a carrier wave though the carrier wave is not limited thereto.

The on-vehicle transmitting unit 14 is a circuit for modulating the signal output from the control unit 11 into a signal in the LF band and individually transmitting the modulated signal from the multiple LF transmitting antennas 14a to the respective detection devices 2. A radio wave of the LF band in the range of 30 to 300 kHz is employed as a carrier wave though the carrier wave is not limited thereto.

The on-vehicle transmitting unit 14 further includes a transmission strength changing unit 14b for changing the transmission strength of a signal to be transmitted from each LF transmitting antenna 14a. The transmission strength changing unit 14b is an amplifier, for example, and changes the transmission strength of a request signal to be transmitted from each of the LF transmitting antennas 14a according to the control by the control unit 11.

The time counting unit 15 is formed by a timer and a real-time clock, for example, and starts counting time according to the control by the control unit 11 as well as gives the result obtained by counting to the control unit 11.

The in-vehicle communication unit 16 is a communication circuit for performing communication according to a communication protocol such as the controller area network (CAN) and the local interconnect network (LIN), and is connected to the reporting device 4. The in-vehicle communication unit 16 transmits pressure information of the tire 3 to the reporting device 4 according to the control by the control unit 11.

The reporting device 4 is audio equipment with a display or a speaker, a display provided in a measuring instrument of the instrument panel or the like for reporting information concerning the pressure of the tire 3 transmitted from the in-vehicle communication unit 16 by an image or by voice. The display unit is a liquid crystal display, an organic electroluminescent display, a head-up display or the like. For example, the reporting device 4 displays air pressures of the respective tires 3 mounted on the vehicle C.

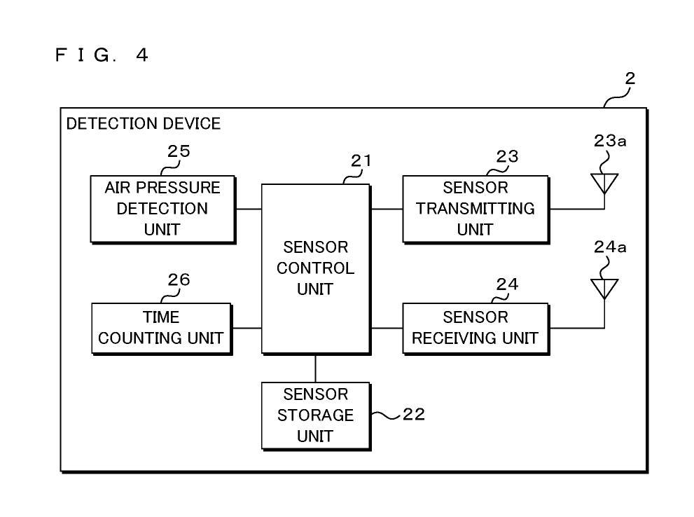

FIG. 4 is a block diagram illustrating an example of the configuration of the detection device 2. The detection device 2 includes a sensor control unit 21 for controlling operation of respective components of the detection device 2. The sensor control unit 21 is connected to a sensor storage unit 22, a sensor transmitting unit 23, a sensor receiving unit 24, an air pressure detection unit 25 and a time counting unit 26.

The sensor control unit 21 is a microcomputer including one or more CPUs, a multi-core CPU, ROM, RAM and an input/output interface and so on. The CPU of the sensor control unit 21 is connected to the sensor storage unit 22, the sensor transmitting unit 23, the sensor receiving unit 24, the air pressure detection unit 25 and the time counting unit 26 via the I/O interface. The sensor control unit 21 reads out control programs stored in the sensor storage unit 22 and controls the respective components. The detection device 2 has a battery (not illustrated) and is operated by the electric power from the battery.

The sensor storage unit 22 is a non-volatile memory. The sensor storage unit 22 stores control programs for executing processing concerning detection and transmission of air pressure of each tire 3 by the CPU of the sensor control unit 21.

The air pressure detection unit 25 is provided with a diaphragm, for example, and detects the pressure of each tire 3 based on the deformation amount of the diaphragm that changes depending on the magnitude of the pressure. The air pressure detection unit 25 outputs a signal indicative of air pressure of each tire 3 to the sensor control unit 21. The sensor control unit 21 detects air pressure of each tire 3 by the air pressure detection unit 25 by executing the control program, generates an air pressure signal including air pressure information obtained by the detection and information on a sensor identifier or the like unique to the detection device 2, and outputs the signal to the sensor transmitting unit 23.

Note that a temperature detection unit (not illustrated) for detecting the temperature of a tire 3 and outputting a signal indicative of the detected temperature to the sensor control unit 21 may be included. In this case, the sensor control unit 21 generates an air pressure signal including information such as air pressure, temperature, a sensor identifier and so on and outputs the signal to the sensor transmitting unit 23.

The sensor transmitting unit 23 is connected to an RF transmitting antenna 23a. The sensor transmitting unit 23 modulates the air pressure signal generated by the sensor control unit 21 into a signal in the UHF band and transmits the modulated air pressure signal by using the RF transmitting antenna 23a.

The sensor receiving unit 24 is connected to an LF receiving antenna 24a. The sensor receiving unit 24 receives a request signal transmitted from the monitoring device 1 by a radio wave in the LF band with the LF receiving antenna 24a and outputs the received signal to the sensor control unit 21.

The following describes procedures for transmission strength adjustment processing for request signals and tire pressure monitor processing.

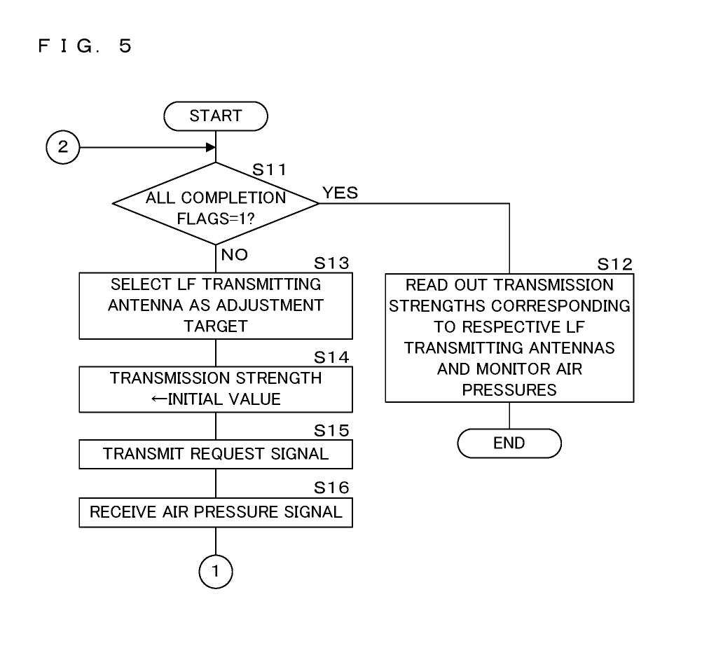

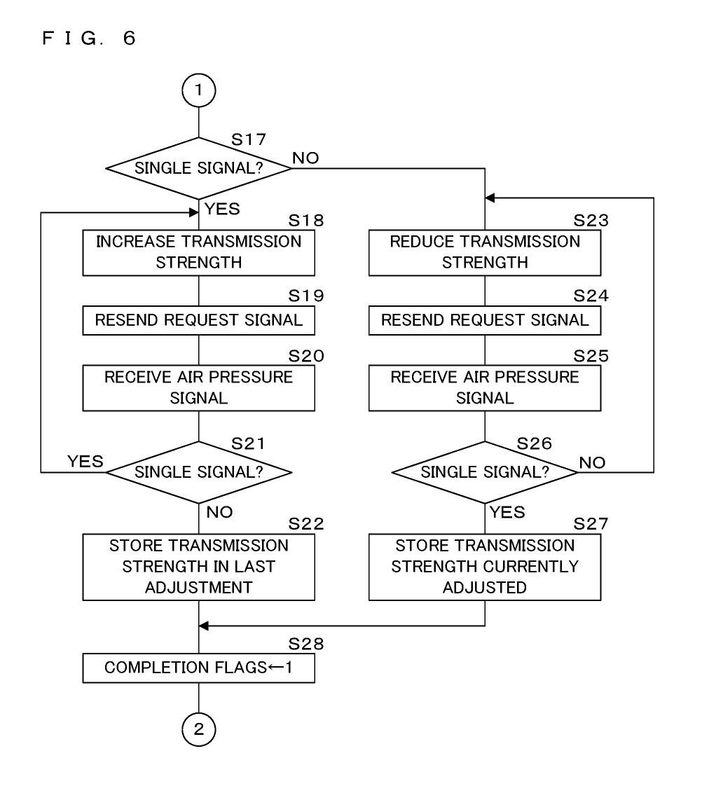

FIG. 5 and FIG. 6 are flowcharts illustrating transmission strength adjustment processing procedure and tire pressure monitor processing according to Embodiment 1. The control unit 11 executes the following processing at any timing when air pressure information is requested. According to Embodiment 1, at least the timing when an ignition switch is switched from an OFF state to an ON state is included. The control unit 11 determines whether or not all the completion flags of the respective LF transmitting antennas 14a are turned on, i.e. _1: (step S11). If it is determined the completion flags of all the LF transmitting antennas 14a are turned on, i.e. _1: (step S11: YES), the control unit 11 reads out the transmission strengths corresponding to the respective LF transmitting antennas 14a from the transmission strength table and monitors the air pressures of the respective tires 3 by utilizing the transmission strengths read out (step S12). After completion of monitoring, the control unit 11 ends the processing. More specifically, the control unit 11 transmits a request signal from each LF transmitting antenna 14a corresponding to each of the tire positions at a transmission strength associated with the LF transmitting antenna 14a. As will be described later, adjustment of the transmission strength of the request signal has been completed, and thus in response to a request signal transmitted to each tire position, an air pressure signal is transmitted from a single detection device 2. The control unit 11 receives an air pressure signal transmitted from the detection device 2 in response to each request signal and monitors the air pressure of each tire based on the air pressure information included in the air pressure signal.

If it is determined that the completion flags of part of the LF transmitting antennas 14a are turned off, i.e. _0: (step S11: NO), the control unit 11 selects the LF transmitting antenna 14a for which the completion flag is set to _0:, that is, one of the LF transmitting antennas 14a as a target on which transmission strength adjustment is performed (hereinafter referred to as an adjustment target) is selected (step S13). The control unit 11 then sets a predetermined initial value as a transmission strength of the selected LF transmitting antenna 14a (step S14). Next, the control unit 11 causes the one LF transmitting antenna 14a selected at step S13 to transmit a request signal at the transmission strength set at step S14 (step S15). The control unit 11 then receives an air pressure signal transmitted from the detection device 2 in response to the request signal transmitted at step S15 (step S16).

The control unit 11 that has completed the processing at step S16 determines whether or not an air pressure signal transmitted from a single detection device 2 is received in a predetermined time period after transmitting the request signal (step S17). If it is determined that an air pressure signal transmitted from a single detection device 2 is received (step S17: YES), the control unit 11 increases the transmission strength of a request signal by a predetermined amount (step S18). Then, the control unit 11 causes the one LF transmitting antenna 14a selected at step S13 to resend a request signal at the increased transmission strength (step S19).

Subsequently, the control unit 11 receives an air pressure signal transmitted from the detection device 2 in response to the request signal resent at step S19 (step S20). The control unit 11 then determines whether or not an air pressure signal transmitted from a single detection device 2 is received in a predetermined time period after resending the request signal (step S21). If it is determined that an air pressure signal transmitted from a single detection device 2 is received (step S21: YE S), the control unit 11 returns the processing to step S18, and repeatedly executes the processing for increasing the transmission strength of the request signal until it receives a plurality of air pressure signals.

If it is determined that air pressure signals transmitted from a plurality of detection devices 2 are received (step S21: NO), the control unit 11 selects the transmission strength set in the last transmission strength adjustment processing as a transmission strength of the one LF transmitting antenna 14a being an adjustment target and stores it in the storage unit 12 (step S22). More specifically, the control unit 11 registers in the transmission strength table the antenna identifier for identifying the one LF transmitting antenna 14a as an adjustment target and the transmission strength set in the last adjustment processing in association with each other.

If it is determined an air pressure signal transmitted from a single detection device 2 is not received at step S17 (step S17: NO), the control unit 11 reduces the transmission strength of the request signal by a predetermined amount (step S23). Note that examples of a situation where an air pressure signal transmitted from a single detection device 2 is not received include a situation where air pressure signals transmitted from a plurality of detection devices 2 are received and a situation where a timeout occurs without reception of an air pressure signal. The control unit 11 then causes the one LF transmitting antenna 14a selected at step S13 to resend a request signal at the reduced transmission strength (step S24).

Subsequently, the control unit 11 receives an air pressure signal transmitted from the detection device 2 in response to the request signal resent at step S24 (step S25). The control unit 11 determines whether or not an air pressure signal transmitted from a single detection device 2 is received during a predetermined time period after transmitting the request signal (step S26). If it is determined that an air pressure signal transmitted from a single detection device 2 is not received (step S26: NO), the control unit 11 returns the processing to step S23 and repeatedly executes the processing for reducing the transmission strength of the request signal until it receives an air pressure signal transmitted from a single detection device 2.

If it is determined that an air pressure signal transmitted from a single detection device 2 is received (step S26: YES), the control unit 11 selects the transmission strength currently adjusted as a transmission strength of the one LF transmitting antenna 14a being an adjustment target and stores it in the storage unit 12 (step S27). More specifically, the control unit 11 registers in the transmission strength table the antenna identifier for identifying the one LF transmitting antenna 14a as an adjustment target and the currently adjusted transmission strength in association with each other.

The control unit 11 that has completed the processing at step S22 or step S27 sets _1: to the completion flag of the one LF transmitting antenna 14a for which transmission strength adjustment is completed (step S28) and returns the processing to step S11.

According to the tire pressure monitoring system in Embodiment 1 thus configured, the monitoring device 1 changes the transmission strength of a request signal such that a single detection device 2 responds to a request signal transmitted from each LF transmitting antenna 14a by the processing at steps S13 to S28, and whereby it is possible to prevent occurrence of interference between the air pressure signals from the detection devices 2 provided in the tires 3 at the respective tire positions and to receive a desired air pressure signal.

Furthermore, in the case where the monitoring device 1 receives an air pressure signal transmitted from a single detection device 2 in response to a request signal transmitted upon the adjustment of transmission strength of a request signal, the monitoring device 1 increases the transmission strength of a request signal by one level. Accordingly, the detection device 2 is more likely to successfully receive a request signal while the monitoring device 1 may receive an air pressure signal.

Since each tire 3 rotates, the positional relation between the detection device 2 provided in each tire 3 and the LF transmitting antenna 14a in the monitoring device 1 changes. Thus, even if a request signal transmitted from the monitoring device 1 is received by each detection device 2 upon adjustment of a request signal, rotation of the tire 3 may extend the distance between the LF transmitting antenna 14a and the detection device 2, which may cause the detection device 2 not to receive a request signal.

As in the present embodiment, however, by increasing the transmission strength of a request signal by one level, the detection device 2 may receive a request signal even if each tire 3 rotates to change the positional relation between the LF transmitting antenna 14a and the detection device 2 while the monitoring device 1 may receive an air pressure signal transmitted from the detection device 2 in response to the request signal.

Moreover, in the case where the monitoring device 1 have increased the transmission strength of a request signal, it resends a request signal. When an air pressure signal transmitted from a single detection device 2 in response to this request signal is received, the transmission strength of the request signal is further increased. Accordingly, the detection device 2 may be much more likely to successfully receive a request signal while the monitoring device 1 may receive an air pressure signal.

Additionally, the monitoring device 1 gradually increases the transmission strength of a request signal until air pressure signals transmitted from the plurality of detection devices 2 are received upon adjustment of the transmission strength of a request signal, and reduces the transmission strength of a request signal by one level when receiving air pressure signals transmitted from the plurality of detection devices 2.

Thus, according to Embodiment 1, it is possible to prevent an air pressure signal from being transmitted from a detection device 2 other than the detection device 2 that is requested to transmit an air pressure signal and to also set the transmission strength of a request signal to maximum.

In addition, in the case where the monitoring device 1 does not receive an air pressure signal transmitted from a single detection device 2 in response to a request signal transmitted from one of the LF transmitting antennas 14a upon adjustment of the transmission strength of a request signal, the monitoring device 1 reduces the transmission strength of a request signal to be transmitted from the one LF transmitting antenna 14a. By reducing the transmission strength of a request signal, the detection device 2 in the tire 3 at a position other than the tire position corresponding to the one LF transmitting antenna 14a may be less likely to receive a request signal.

Furthermore, in the case where the monitoring device 1 have reduced the transmission strength of a request signal of the one LF transmitting antenna 14a, it resends a request signal. In the case where the number of air pressure signals transmitted in response to this request signal is not one, the transmission strength of the request signal is further reduced. By further reducing the transmission strength of the request signal, the detection device 2 in the tire 3 at a position other than the tire position corresponding to the one LF transmitting antenna 14a may be much less likely to receive a request signal.

Additionally, the monitoring device 1 gradually reduces the transmission strength of the request signal until it receives an air pressure signal transmitted from a single detection device 2.

Thus, according to Embodiment 1, it is possible to prevent an air pressure signal from being transmitted from a detection device 2 other than the detection device 2 that is requested to transmit an air pressure signal and to also set the transmission strength of a request signal to be large.

Moreover, according to the present embodiment, by storing a transmission strength of a request signal suitable for each LF transmitting antenna 14a in the storage unit 12, the monitoring device 1 causes each LF transmitting antenna 14a to transmit a request signal by using the transmission strength stored in the storage unit 12 from that time onward and may monitor the air pressure of each of the tires 3.

Embodiment 1 has mainly described the embodiment relating to the tire pressure monitoring system, and hardware associated with wireless communication of the tire pressure monitoring system may be shared with another communication system as well. For example, the hardware associated with wireless communication may be commonly used to form a vehicle communication system including the TPMS and the passive entry system.

The passive entry system is formed by the monitoring device 1 and a mobile machine associated with the passive entry system. The monitoring device 1 performs wireless communication with a mobile machine possessed by the user, performs authentication for the mobile machine and detects the position of the mobile machine. A touch sensor (not illustrated) is provided in a door handle of the vehicle C. If an authenticated mobile machine is located outside the vehicle, that is, if a touch of the user's hand on the door handle is detected by the touch sensor, if a door switch is pressed, and so forth, the monitoring device 1 executes processing of locking or unlocking of the door of the vehicle C. The monitoring device 1 sets the transmission strength of the signal to be transmitted from the LF transmitting antenna 14a to high when performing wireless communication with the mobile machine and sets the transmission strength of the signal to be transmitted from the LF transmitting antenna 14a to low when transmitting a request signal to the detection device 2.

Note that the passive entry system forming the vehicle communication system is one example, and the present invention may be applied to a system in which wireless communication is performed between a mobile machine and the monitoring device 1 to perform various vehicle control. For example, the vehicle communication system may be formed by the TPMS as well as a smart start system that allows a motor mounted on the vehicle to start without using a keyless entry system, a mechanical key or the like.

### Embodiment 2

The configuration of the tire pressure monitoring system according to Embodiment 2 is similar to that of Embodiment 1 but is different from Embodiment 1 only in transmission strength adjustment processing procedure. Thus, the difference will mainly be described below. The other configuration and effect are similar to those in Embodiment 1, and similar symbolic codes are applied to corresponding parts while the detail will not be described here.

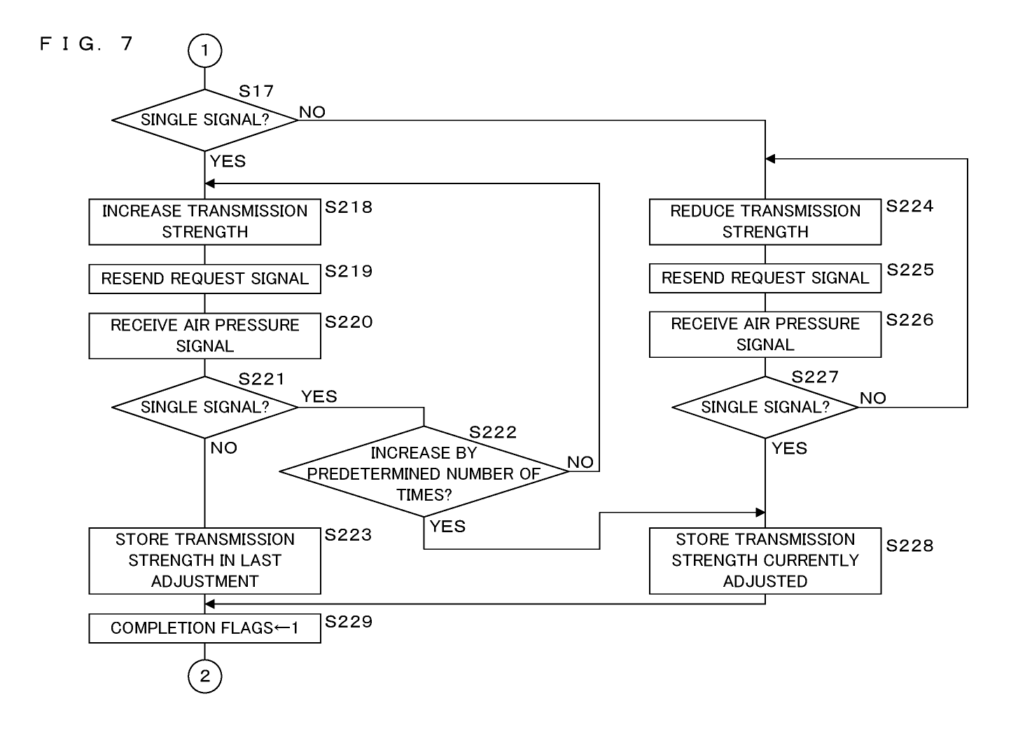

FIG. 7 is a flowchart illustrating transmission strength adjustment processing procedure and tire pressure monitor processing according to Embodiment 2. The monitoring device 1 according to Embodiment 2 executes processing similar to that at steps S11-S17 in Embodiment 1.

If it is determined an air pressure signal transmitted from a single detection device 2 is received (step S17: YES), the control unit 11 increases the transmission strength of a request signal by a predetermined amount (step S218). The control unit 11 then causes one of the LF transmitting antennas 14a selected at step S13 to resend a request signal at the increased transmission strength (step S219).

Subsequently, the control unit 11 receives an air pressure signal transmitted from the detection device 2 in response to the request signal resent at step S219 (step S220). The control unit 11 then determines whether or not an air pressure signal transmitted from a single detection device 2 is received during a predetermined time period after resending the request signal (step S221). If it is determined that an air pressure signal transmitted from a single detection device 2 is received (step S221: YES), the control unit 11 determines whether or not the transmission strength is increased by a predetermined number of times (step S222). It is noted that a predetermined number of times is not limited to a particular number, and one time or multiple times may be possible. If it is determined that the number of times of increasing the transmission strength is less than a predetermined number of times (step S222: NO), the control unit 11 returns the processing to step S218.

If it is determined that an air pressure signal transmitted from a single detection device 2 is not received (step S221: NO), the control unit 11 selects the transmission strength set in the last transmission strength adjustment processing as a transmission strength of the one LF transmitting antenna 14a being an adjustment target and stores it in the storage unit 12 (step S223).

If it is determined that an air pressure signal transmitted from a single detection device 2 is not received at step S17 (step S17: NO), the control unit 11 reduces the transmission strength of a request signal by a predetermined amount (step S224). The control unit 11 then causes the one LF transmitting antenna 14 selected at step S13 to resend a request signal at the reduced transmission strength (step S225).

Subsequently, the control unit 11 receives an air pressure signal transmitted from the detection device 2 in response to the request signal resent at step S225 (step S226). The control unit 11 then determines whether or not an air pressure signal transmitted from a single detection device 2 is received in a predetermined time period after resending the request signal (step S227).

If it is determined that an air pressure signal transmitted from a single detection device 2 is not received (step S 227: NO), the control unit 11 returns the processing to step S224, and repeatedly performs the processing for reducing the transmission strength of the request signal until it receives a single air pressure signal.

If it is determined that an air pressure signal transmitted from a single detection device 2 is received (step S227: YES) or it is determined that the number of times of increasing the transmission strength is a predetermined number of times at step 222 (step S222: YES), the control unit 11 selects the transmission strength currently adjusted as a transmission strength of the one LF transmitting antenna 14a being an adjustment target and stores it in the storage unit 12 (step S228). Then, the control unit 11 that has completed the processing at step S223 or S228 sets _1: to the completion flag of the one LF transmitting antennas 14a for which adjustment of the transmission strength is completed (step S229) and returns the processing to step S11.

With the tire pressure monitoring system according to Embodiment 2 thus configured, in the case where the monitoring device 1 increases the transmission strength of a request signal, it resends a request signal. When the monitoring device 1 receives an air pressure signal transmitted from a single detection device 2 in response to this request signal, it further increases the transmission strength of a request signal.

Note that the number of increasing a request signal is equal to or less than a predetermined number of times. In the case where the transmission strength of a request signal is set too large, even if no problem arises at a time when the transmission strength of a request signal is set, a detection device 2 of another vehicle may respond to the request signal transmitted from the LF transmitting antenna 14a of its own vehicle C when another vehicle C approaches to its own vehicle C later. Thus, according to Embodiment 2, the transmission strength of a request signal is set to moderate such that a corresponding detection device 2 may receive a request signal transmitted from the LF transmitting antenna 14a and yet, the detection device 2 of another vehicle C does not receive the request signal.

According to Embodiment 2, even if the positional relation between its own vehicle C and another vehicle C located nearby changes, in response to a request signal transmitted from one of the LF transmitting antennas 14a, an air pressure signal may always be transmitted from the corresponding single detection device 2 to the monitoring device 1. Thus, the monitoring device 1 according to Embodiment 2 may prevent interference between air pressure signals transmitted from the detection devices 2 provided in the tires 3 at the respective tire positions and may monitor the air pressure of the respective tires 3.

An example of limiting an increased amount when the transmission strength is increased is described in Embodiment 2 while it may be configured that the transmission strength is further reduced by one time or by a predetermine number of times even after an air pressure signal transmitted from a single detection device 2 is received when the transmission strength is reduced at steps S224 to S227.

### DESCRIPTION OF REFERENCE NUMERALS

1 monitoring device
2 detection device
3 tire
4 reporting device
11 control unit
12 storage unit
13 on-vehicle receiving unit
13a RF receiving antenna
14 on-vehicle transmitting unit
14a LF transmitting antenna
14b transmission strength changing unit
15 time counting unit
16 in-vehicle communication unit
21 sensor control unit
22 sensor storage unit
23 sensor transmitting unit
23a RF transmitting antenna
24 sensor receiving unit
24a LF receiving antenna
25 air pressure detection unit
26 time counter
C vehicle

1.-9. (canceled)

10. A monitoring device that receives an air pressure signal transmitted from each of a plurality of detection devices that are provided in respective ones of a plurality of tires of a vehicle in response to a request signal requesting air pressure of each of the tires, to monitor air pressure of each of the tires, comprising:
a request signal transmitting unit that transmits the request signal to a region including at least one tire position where one of the tires is provided;
an air pressure signal receiving unit that receives the air pressure signal transmitted from each of the detection devices in response to the request signal with respect to the region transmitted by the request signal transmitting unit;
a determination unit that determines whether or not the air pressure signal transmitted from one of the detection devices is received by the air pressure signal receiving unit; and
a transmission strength changing unit that increases or reduces a transmission strength of the request signal depending on a result determined by the determination unit, wherein
the transmission strength changing unit is configured to increase a transmission strength of the request signal to be transmitted by the request signal transmitting unit so as not to exceed a predetermined number of times as an upper limit until the air pressure signals transmitted from the plurality of detection devices are received in a case where the determination unit determines that the air pressure signal transmitted from one of the detection devices in response to the request signal transmitted is received and to reduce a transmission strength of the request signal to be transmitted by the request signal transmitting unit in a case where the air pressure signals transmitted from the plurality of detection devices are received, and to reduce a transmission strength of the request signal to be transmitted by the request signal transmitting unit until the air pressure signal transmitted from one of the detection devices is received in a case where the determination unit determines that the air pressure signals transmitted from the plurality of detection devices in response to the request signal transmitted are received.

11. The monitoring device according to claim 10, further comprising a storage unit that stores a changed transmission strength in a case where the transmission strength changing unit completes the processing for increasing or decreasing a transmission strength of the request signal, wherein
the request signal is transmitted at a transmission strength stored by the storage unit in a case where the storage unit stores a transmission strength, to monitor air pressure of each of the tires.

12. A tire pressure monitoring system, comprising
a plurality of detection devices that are provided in respective ones of a plurality of tires of a vehicle and each wirelessly transmit an air pressure signal obtained by detecting air pressure of each of the plurality of tires in response to a request signal; and the monitoring device according to claim 10, wherein
the monitoring device receives the air pressure signals transmitted from the plurality of detection devices, to monitor air pressure of the respective tires.
